(19) United States
(12) Patent Application Publication
(10) Pub. No.: US 2012/0268753 A1
(43) Pub. Date: Oct. 25, 2012

(54) INFORMATION PROCESSING APPARATUS, PRINT SETTING METHOD, AND COMPUTER-READABLE MEDIUM

(75) Inventor: Akihiko Tokuda, Yokohama-shi (JP)

(73) Assignee: CANON KABUSHIKI KAISHA, Tokyo (JP)

(21) Appl. No.: 13/446,704

(22) Filed: Apr. 13, 2012

(30) Foreign Application Priority Data
Apr. 21, 2011 (JP) 2011-095282

(51) Int. Cl. G06K 15/02

(52) U.S. Cl. 358/1.2

(57) ABSTRACT

An information processing apparatus comprises: a holding unit configured to hold an output size and a paper type to be used by a printing apparatus when printing original data; a conflict processing unit configured to determine, based on a conflict condition, a conflict relationship representing an unselectable combination of a size and a type of paper; and a priority setting reception unit configured to receive a priority setting for one of the paper type held and a page size designated by the original data under the conflict condition, wherein when the priority setting is done for the paper type, and the paper type and the page size satisfy the conflict relationship, the conflict processing unit changes the output size so as not to satisfy the conflict relationship to the paper type while keeping setting of the page size unchanged.

### BACKGROUND OF THE INVENTION

1. Field of the Invention

The present invention relates to an information processing apparatus for instructing printing, a print setting method, and a computer-readable medium and, more particularly, to a method of setting paper to be used in a printing apparatus.

2. Description of the Related Art

In a printer driver installed in a client computer or the like, the setting items of media (paper and the like) to be used in printing conventionally include a paper size representing a size and a paper type representing a property.

On the other hand, certain combinations of a printer engine, options, and wide-ranging functions to be used in printing may yield a disadvantageous printing result for a user. Hence, the printer driver grays out or hides setting items that cannot be used simultaneously in combination from the viewpoint of a mechanism, thereby preventing the user from selecting them (this will be referred to as conflict processing hereinafter).

Some printer drivers allow selecting both a paper size (to be referred to as a “page size” hereinafter) representing the paper size of an original generated by the user and a paper size (to be referred to as an “output size” hereinafter) representing the size of a physical paper sheet to be actually output by a printer.

The user can arbitrarily select paper supported by the printer to be used by him/her and print not only a document generated by himself/herself but also an electronically distributed material or a document acquired from the Internet. For example, although the initial settings of the printer driver include the output size “A4” and the paper type “index paper”, the document to be printed may be generated in a paper size (for example, A3 or 11×17) that does not support the index paper. When printing this document, the user normally executes printing without opening the setting screen of the printer driver. However, the printer driver executes conflict processing as internal processing. For example, the printer driver often executes rounding processing to the initial settings. Especially in conflict processing, the set contents of paper size are often stricter than the setting of paper type, and the paper type is rounded to general plain paper or the like.

For example, in Japanese Patent Laid-Open No. 2010-137923, the configuration information of a printer main body is acquired, and printing is performed for only user-designated paper using the information of paper in each paper feed stage represented by the configuration information, thereby preventing unintended wasteful output.

That is, the paper size designated on the document side cannot be used in the paper type designated by the printer driver. Additionally, to change the settings, the user cumbersomely needs to open the setting screen of the printer driver and change the output size to “A4” or the like.

### SUMMARY OF THE INVENTION

According to one aspect of the present invention, there is provided an information processing apparatus comprising: a holding unit configured to hold an output size and a paper type to be used by a printing apparatus when printing original data; a conflict processing unit configured to determine, based on a predetermined conflict condition, a conflict relationship representing an unselectable combination of a size and a type of paper; and a priority setting reception unit configured to receive a priority setting for one of the paper type held by the holding unit and a page size designated by the original data under the predetermined conflict condition, wherein when the priority setting is done for the paper type, and the paper type and the page size satisfy the conflict relationship, the conflict processing unit changes the output size so as not to satisfy the conflict relationship to the paper type while keeping setting of the page size unchanged.

According to another aspect of the present invention, there is provided an information processing apparatus comprising: a holding unit configured to hold an output size and a paper type to be used by a printing apparatus when printing original data; a conflict processing unit configured to determine, based on a predetermined conflict condition, a conflict relationship representing an unselectable combination of a size and a type of paper; a setting change reception unit configured to display an output image of the original data and to receive a setting change for the original data; and a priority setting reception unit configured to receive a priority setting for one of the paper type held by the holding unit and a page size designated by the original data under the predetermined conflict condition, wherein when the priority setting is done for the paper type, and the paper type and the page size satisfy the conflict relationship, the conflict processing unit changes the output size so as not to satisfy the conflict relationship to the paper type while keeping setting of the page size unchanged, and the setting change reception unit displays the output image and receives a change of the output size from a user.

According to another aspect of the present invention, there is provided a print setting method comprising: a holding step of holding, in a storage unit in advance, an output size and a paper type to be used by a printing apparatus when printing original data; a conflict processing step of determining, based on a predetermined conflict condition, a conflict relationship representing an unselectable combination of a size and a type of paper; and a priority setting reception step of receiving a priority setting for one of the paper type held in the storage unit and a page size designated by the original data under the predetermined conflict condition, wherein when the priority setting is done for the paper type, and the paper type and the page size satisfy the conflict relationship, in the conflict processing step, the output size is changed so as not to satisfy the conflict relationship to the paper type while keeping setting of the page size unchanged.

According to another aspect of the present invention, there is provided a print setting method comprising: a holding step of holding, in a storage unit in advance, an output size and a paper type to be used by a printing apparatus when printing original data; a conflict processing step of determining, based on a predetermined conflict condition, a conflict relationship representing an unselectable combination of a size and a type of paper; a setting change reception step of displaying an output image of the original data and receiving a setting change for the original data; and a priority setting reception step of receiving a priority setting for one of the paper type held in the storage unit and a page size designated by the original data under the predetermined conflict condition, wherein when the priority setting is done for the paper type, and the paper type and the page size satisfy the conflict relationship, in the conflict processing step, the output size is changed so as not to satisfy the conflict relationship to the paper type while keeping setting of the page size unchanged, and in the setting change reception step, the output image is displayed, and a change of the output size from a user is received.

According to another aspect of the present invention, there is provided a computer-readable medium storing a program that causes a computer to function as: holding unit configured to hold an output size and a paper type to be used by a printing apparatus when printing original data; conflict processing unit configured to determine, based on a predetermined conflict condition, a conflict relationship representing an unselectable combination of a size and a type of paper; and priority setting reception unit configured to receive a priority setting for one of the paper type held by the holding unit and a page size designated by the original data under the predetermined conflict condition, wherein when the priority setting is done for the paper type, and the paper type and the page size satisfy the conflict relationship, the conflict processing unit changes the output size so as not to satisfy the conflict relationship to the paper type while keeping setting of the page size unchanged.

According to another aspect of the present invention, there is provided a computer-readable medium storing a program that causes a computer to function as: a holding unit configured to hold an output size and a paper type to be used by a printing apparatus when printing original data; a conflict processing unit configured to determine, based on a predetermined conflict condition, a conflict relationship representing an unselectable combination of a size and a type of paper; a setting change reception unit configured to display an output image of the original data and to receive a setting change for the original data; and a priority setting reception unit configured to receive a priority setting for one of the paper type held by the holding unit and a page size designated by the original data under the predetermined conflict condition, wherein when the priority setting is done for the paper type, and the paper type and the page size satisfy the conflict relationship, the conflict processing unit changes the output size so as not to satisfy the conflict relationship to the paper type while keeping setting of the page size unchanged, and the setting change reception unit displays the output image and receives a change of the output size from a user.

According to the present invention, it is possible to print various kinds of documents on desired paper by a simple operation.

Further features of the present invention will become apparent from the following description of exemplary embodiments (with reference to the attached drawings).

### BRIEF DESCRIPTION OF THE DRAWINGS

FIG. 1 is a view showing the system configuration of a printing system;

FIG. 2 is a block diagram of a client computer;

FIG. 3 is a block diagram showing the module configuration of a printer driver;

FIG. 4 is a flowchart of a printer driver installation method;

FIGS. 5A and 5B are views for explaining examples of display provided by a conventional printer driver;

FIG. 6 is a view showing an example of display provided by the conventional printer driver;

FIG. 7 is a view showing an example of display provided by a printer driver according to the first embodiment;

FIG. 8 is a flowchart illustrating processing according to the first embodiment;

FIGS. 9A and 9B are views showing examples of display provided by the printer driver according to the first embodiment;

FIG. 10 is a view showing an example of display provided by the printer driver according to the first embodiment;

FIG. 11 is a flowchart illustrating processing according to the first embodiment;

FIG. 12 is a view showing an example of display provided by the printer driver according to the first embodiment; and

FIGS. 13A, 13B, and 13C are views showing examples of display provided by a printer driver according to the second embodiment.

### DESCRIPTION OF THE EMBODIMENTS

### First Embodiment

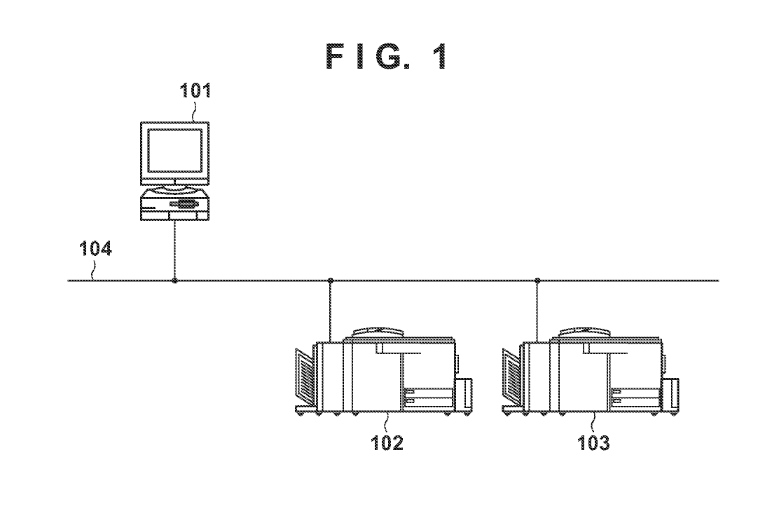

The first embodiment of the present invention will be described with reference to FIGS. 1 to 12.

[System Configuration]

FIG. 1 shows an example of the configuration of a printing system to which the present invention is applicable. In the printing system shown in FIG. 1, a client computer 101 and network printers 102 and 103 are connected through a computer network 104. Note that the configuration is not limited to this, and various kinds of other apparatuses may be connected.

An operating system (to be referred to as an OS hereinafter), various kinds of applications, and printer drivers are installed in the client computer 101. The user can send various kinds of print data from the client computer 101 to the network printers 102 and 103 and cause them to print. The network printers 102 and 103 print various kinds of received print data. Note that each of the network printers 102 and 103 can be either a printing apparatus having only a printing function or an MFP (MultiFunction Peripheral) having other functions as well.

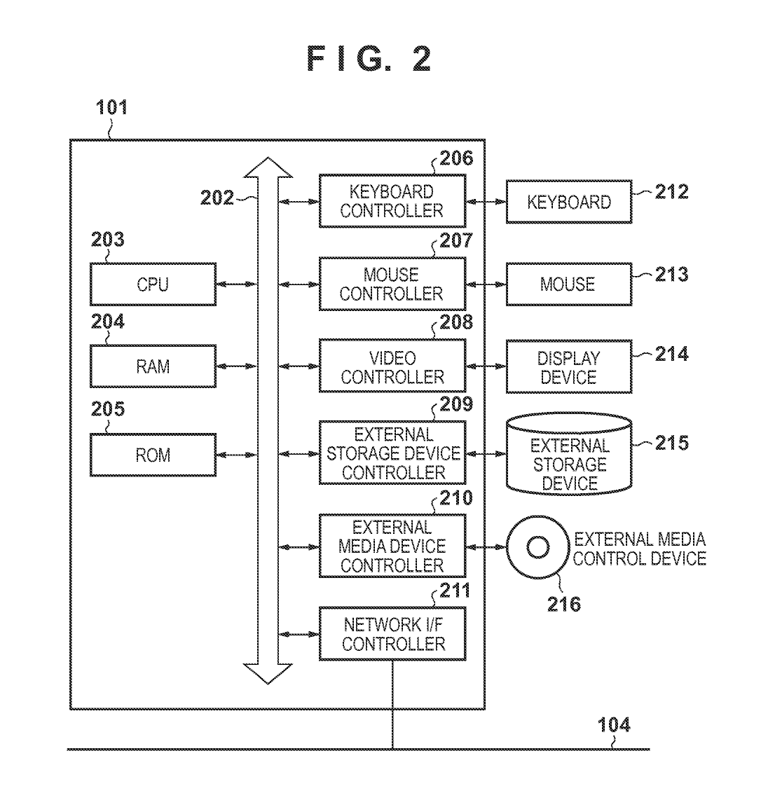

FIG. 2 is a block diagram showing an example of the internal blocks of the client computer 101 serving as an information processing apparatus according to this embodiment. The client computer 101 includes a CPU (Central Processing Unit) 203, a RAM (Random Access Memory) 204 that is a volatile memory, a ROM (Read Only Memory) 205 that is a nonvolatile memory, a keyboard controller 206, a mouse controller 207, a video controller 208, an external storage device controller 209, an external media device controller 210, and a network I/F controller 211.

A keyboard 212 and a mouse 213, which are used by the user to operate the client computer 101, are connected to the keyboard controller 206 and the mouse controller 207, respectively. A display device 214 is connected to the video controller 208. A nonvolatile external storage device 215 to store an enormous amount of data is connected to the external storage device controller 209 to read or write applications and data. The external media device controller 210 controls an external media control device 216. When an application or driver software is provided by an external medium (CD-ROM or DVD-ROM), the user can set the medium such as a CD-ROM in the external media control device 216 so as to read the program. The client computer 101 is connected to the computer network 104 described with reference to FIG. 1 through the network I/F controller 211 to communicate with another device.

The initial program to activate the client computer 101 and basic programs to control the modules of the client computer 101 are normally stored in the ROM 205. The OS, applications, and printer drivers are stored in the external storage device 215. When the client computer 101 is powered on, a program (boot loader) stored in the ROM 205 to activate the computer is executed first. This program loads the OS stored in the external storage device 215 to the RAM 204 and then transfers the control to the OS. The OS further loads necessary modules and drivers from the external storage device 215 to the RAM 204. The OS also loads necessary applications from the external storage device 215 to the RAM 204 and executes them in accordance with user instructions.

The printer driver and a printer driver installer to be described in this embodiment are supplied from an external medium such as a CD-ROM. In this case, the user sets the CD-ROM in the external media control device 216. The CPU 203 loads the driver and the printer driver installer to the RAM 204 or stores them in the external storage device 215 as needed.

Note that the configuration of the client computer 101 is not limited to the above-described configuration and may include any other constituent elements.

[Printer Driver Installation]

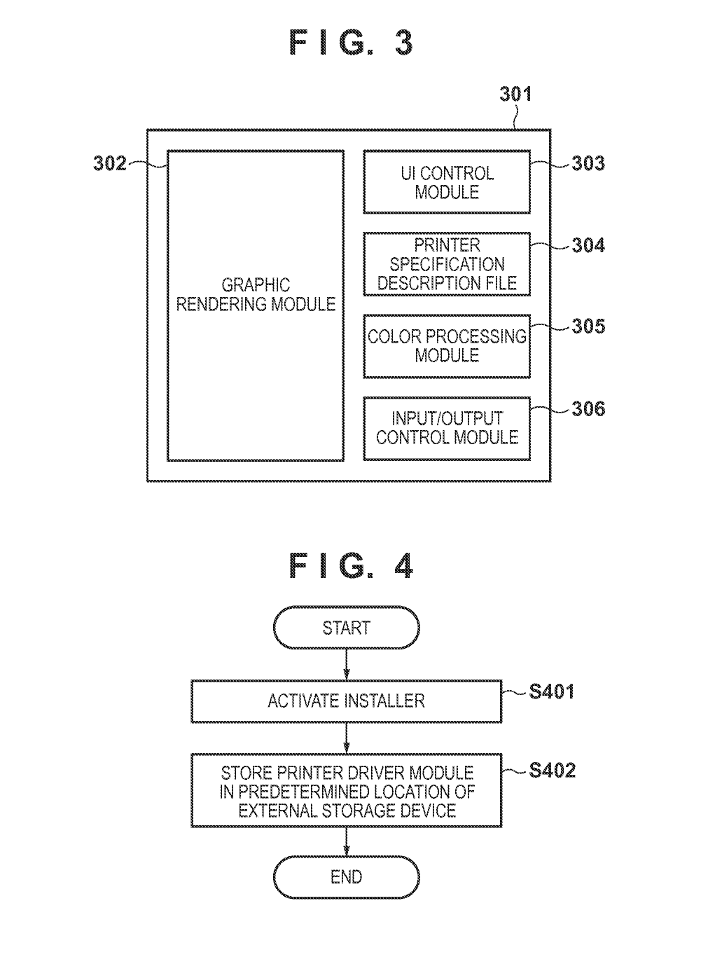

The printer driver will be explained next. In this embodiment, the printer driver installed in the client computer 101 includes modules shown in FIG. 3. A printer driver 301 includes a graphic rendering module 302, a UI control module 303, a printer specification description file 304, a color processing module 305, and an input/output control module 306. The printer driver may include any other modules depending on its functions. The graphic rendering module 302 issues a page description language and printer control commands in accordance with the specifications of each printer. The UI control module 303 displays and controls a UI in accordance with the printer specification description file 304. The printer specification description file describes specifications related to the printer supported by the printer driver 301.

The printer driver 301 can further include several components based on the above-described configuration. For example, to cause one printer driver to support a plurality of printers, the graphic rendering module 302 and the UI control module 303 may be generated to support a plurality of printers. As for the printer specification description file 304, files as many as the supported printers may be packed together with the printer driver 301.

A procedure of installing the printer driver 301 having the above-described configuration in the client computer 101 will be described next. FIG. 4 illustrates the procedure of installing the printer driver. Note that the user prepares the CD-ROM that stores the printer driver or acquires the printer driver installer (not shown) via a network.

In step S401, the user activates the acquired printer driver installer. In step S402, the printer driver installer stores the printer driver module in a predetermined location of the external storage device 215. The storage location changes depending on the printing system. In, for example, Windows7®, the printer driver module is stored in a directory
¥Windows¥system32 [symbol] spool [symbol] drivers [symbol] w32x86
   Printer driver installation is thus completed.

[Method of Holding Printer Driver Set Contents]

The printer driver assigns initial setting information internally held at the time of installation to all setting items. These contents are registered in the following storage unit called a registry, which is managed by the OS. The following are examples of setting item holding destinations in the registry.

Note that the storage destinations are not limited to the following examples.
HKEY_CURRENT_USER¥Software
HKEY_LOCAL_MACHINE¥SOFTWARE [symbol]
HKEY_LOCAL_MACHINE¥SYSTEM

[symbol]

[Method of Displaying Paper Size and Paper Type]

In this embodiment, the printing apparatus can handle various kinds of paper. Paper size information and paper type information are defined for each paper. The paper sizes include, for example, so-called standard sizes such as A5, A4, B4, letter, postcard, and long form No. 3, and nonstandard sizes that freely combine the vertical and horizontal sizes within the range from the maximum to minimum passable size of the printer engine to be used for printing. On the other hand, the paper types include general paper such as plain paper, thick paper, and thin paper, and specialty paper such as embossed paper, vellum paper, coated paper, and OHP sheet. Each paper type is sometimes subdivided by grammage (weight per unit area).

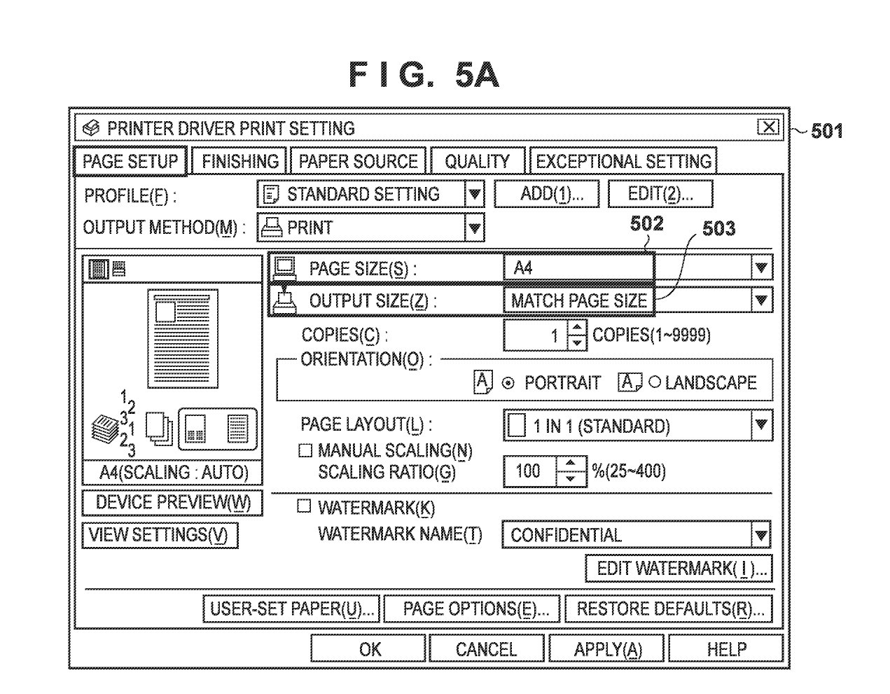

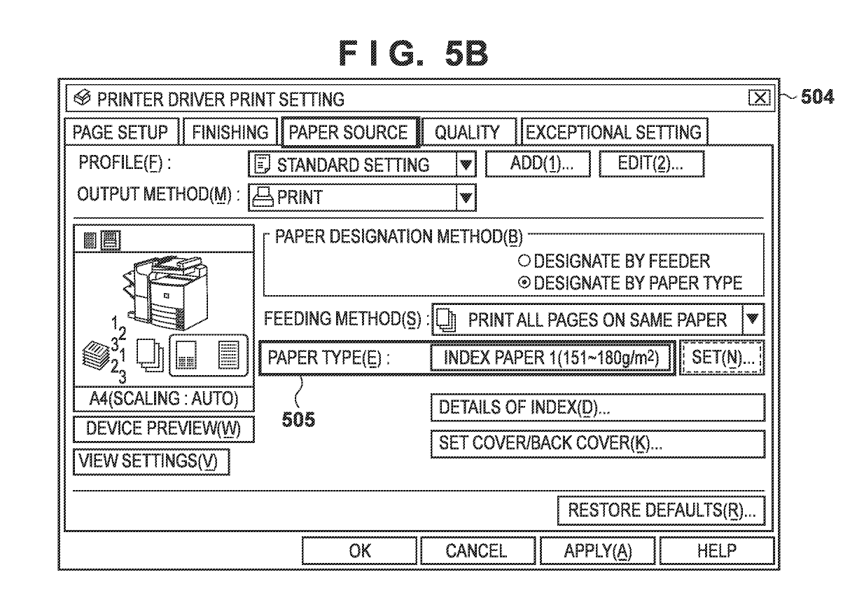

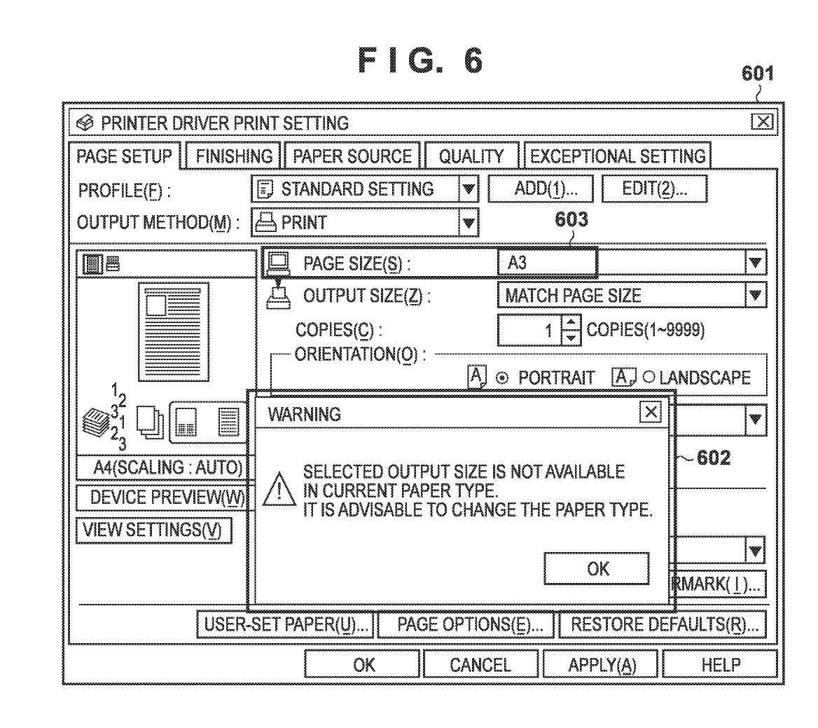

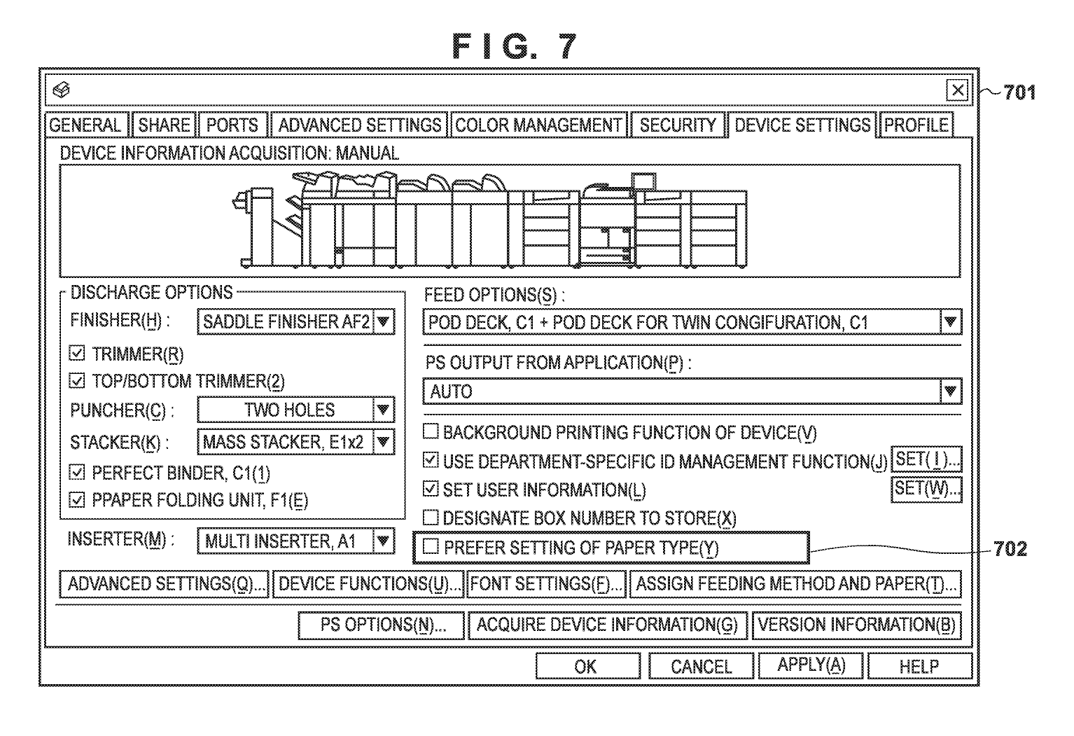

Display examples of screens provided by a conventional printer driver will be described with reference to FIGS. 5A, 5B, and 6. As described above, the conventional printer driver handles, on its user interface, a “page size” representing the original paper size for original data generated by an application and an “output size” representing paper the printer main body for the printer driver can feed and discharge. For the “page size”, the application can also rewrite the information of the “page size” of the printer driver and execute print processing without displaying the setting screen (user interface) of the printer driver. In, for example, the Windows® system, the information of “page size” is called DEVMODE.

On the other hand, the “output size” is used to print original data generated in, for example, A4 size on another paper size (for example, A3 size) without changing the layout of the original for the paper size. Note that most generally, the “output size” is displayed as “match page size” in the initial settings so that the data is output in the same size as the “page size” of the original generated by the user or application.

For example, in a “page setup” screen 501 shown in FIG. 5A out of the setting screens provided by the printer driver, a “page size” 502 and an “output size” 503 are set. In addition, a “paper type” 505 is set in a “paper source” screen 504 shown in FIG. 5B. FIG. 6 shows an example of a message 602 displayed when “index paper” is selected as the “paper type”, as shown in FIG. 5B, and “A3” is selected as the “page size” (“page size” 603).

The message 602 shown in FIG. 6 prompts the user to change the “paper type” when “index paper in A3 size” does not exist (or the printer engine does not support paper of this combination). In this example, since the printer driver gives top priority to the page size designated by the application, the paper size has priority over the paper type.

Note that the combinations of paper sizes and paper types supported by the printer engine are defined in the above-described printer specification description file 304. When the user selects the paper size and the paper type using the keyboard 212 or the mouse 213 at the time of printing or the like, the CPU 203 determines whether the combination is possible. The UI control module 303 executes conflict processing based on predefined conflict conditions, and if the combination is impossible, performs processing of, for example, rounding to the initial settings of the printer driver.

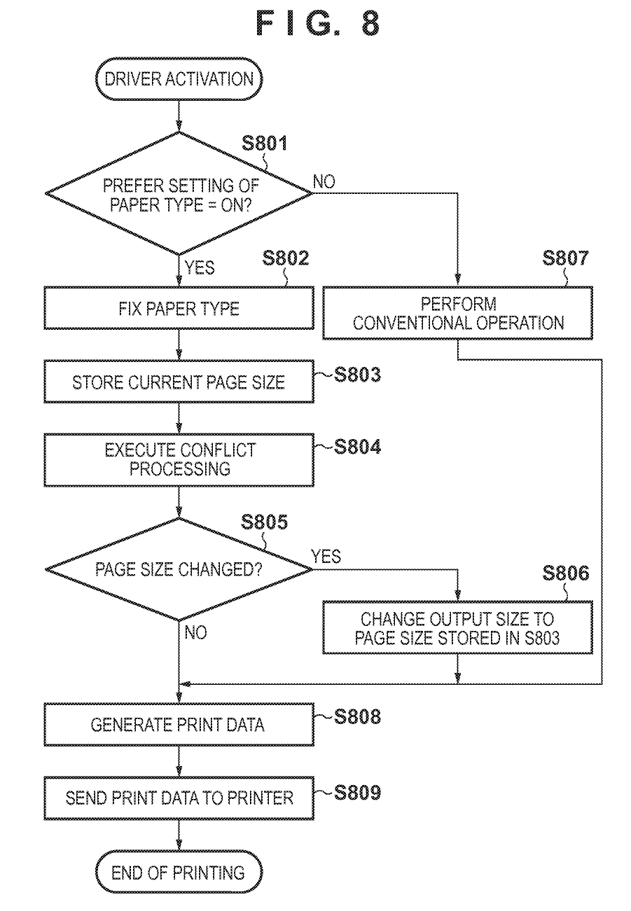

FIG. 7 shows a display example of a function according to this embodiment. A “device setting” screen 701 of the printer driver 301 is provided with a check box 702 “prefer setting of paper type”. The check box 702 implements a priority setting reception unit. The operation of the printer driver 301 when the user selects the check box 702 to decide the priority setting will be described with reference to the flowchart of FIG. 8.

When the printer driver 301 is activated at the time of printing execution by the application, the UI control module 303 determines in step S801 whether the check box 702 “prefer setting of paper type” is selected. If the check box 702 is selected (YES in step S801), the UI control module 303 fixes the “paper type” currently selected in the printer driver 301 to prefer it over selection of the paper size in step S802. In this case, the UI control module 303 executes conflict processing by, for example, setting an internal flag (not shown). In step S803, the UI control module 303 stores, in the storage unit (for example, RAM 204) or the like, the information of the “page size” currently selected in the printer driver 301.

In step S804, when the user who is operating the client computer 101 has set or changed a setting item in a display screen 601 of the printer driver 301, the UI control module 303 executes conflict processing. For example, examine a state in which “index paper” is selected as the “paper type” 505 in the “paper source” screen 504 shown in FIG. 5B, and “A4” is selected as the “page size” 502 in the “page setup” screen 501 shown in FIG. 5A. Assume that in this state, the user changes the “page size” 502 to “A3” that is not supported for “index paper”. At this point of time, the UI control module 303 executes conflict processing by reading the contents described in the printer specification description file 304. The UI control module 303 detects that “index paper” that is the already selected “paper type” and “A3” that is the “page size” selected by the immediately preceding operation have the conflict relationship.

In the related art, the message 602 shown in FIG. 6 is displayed. In this embodiment, however, if the user selects the check box 702 “prefer setting of paper type”, the message to prompt the user to change the “paper type” is not displayed. In this embodiment, the UI control module 303 controls the UI to be described below so as to minimize change of the “paper type”.

In step S805, the UI control module 303 confirms whether the user has changed the “page size” in the conflict processing of step S804. If the “page size” is changed (YES in step S805), in step S806, the UI control module 303 reflects the information of the “page size” stored in the storage unit in step S803 on the “output size”.

This will be described in more detail using the above example. When “index paper” is selected as the “paper type”, and in this state, “A3” that is not supported for the index paper is selected as the “page size”, the conflict processing is performed at this point of time. As the result of conflict processing, since “A3” cannot be selected as the “page size”, the UI control module 303 switches the display of the “output size” to “A4” stored as the “page size”. For example, when the “output size” is set to “match page size” in the initial settings, the setting of the “page size” is changed to “A4”.

If the check box 702 “prefer setting of paper type” is not selected (NO in step S801), the UI control module 303 performs conflict processing as in the related art in step S807. In step S808, the UI control module 303 generates print data. In step S809, the UI control module 303 sends the generated print data to the network printers 102 and 103 via the network I/F controller 211, the computer network 104, and the like.

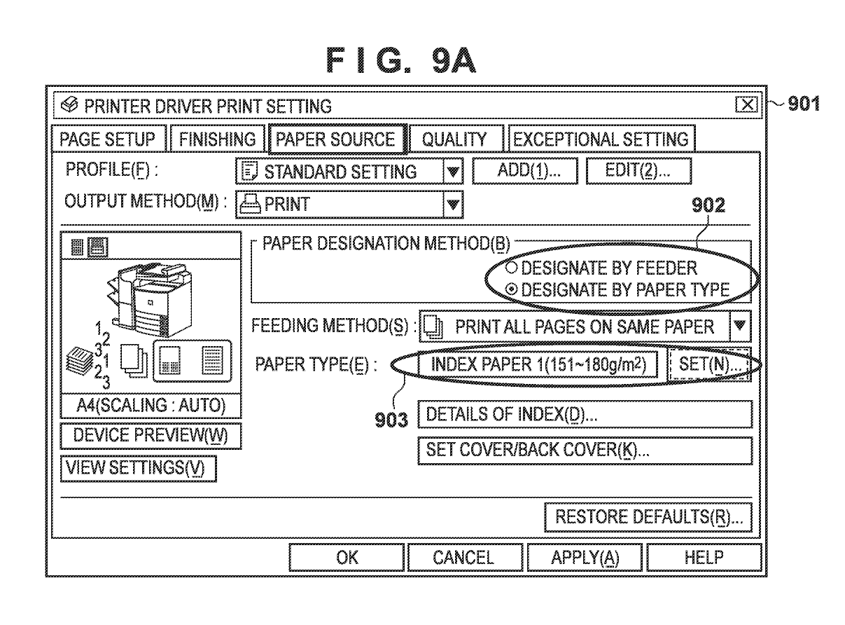

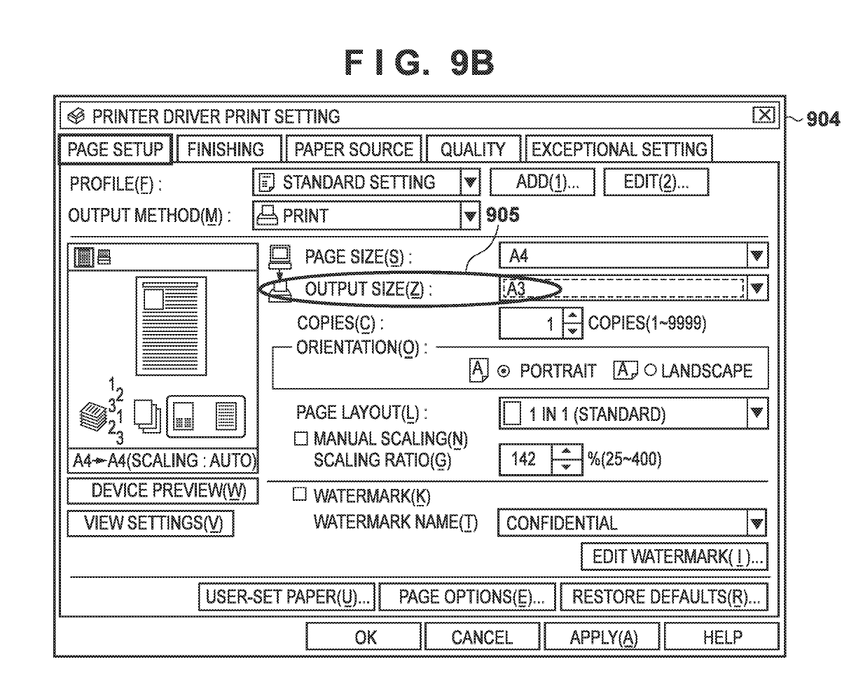

FIGS. 9A and 9B show display results obtained by the conflict processing of the present invention. Assuming that the check box 702 “prefer setting of paper type” is selected, the paper type is designated as in a screen 901 shown in FIG. 9A. The “paper type” is “index paper” here (setting items 902 and 903). In this case, an “output size” 905 is changed to “A3” as in a screen 904 shown in FIG. 9B.

[Designation from Application]

Note that printing can also be executed from a document generation application, spreadsheet software, graphics processing software, or the like installed in the client computer 101 without displaying the user interface of the printer driver 301. These pieces of application software have the information of paper sizes. In, for example, the Windows® system, the information is designated in the printer driver 301 via the above-described DEVMODE.

This will be described in detail using the above example. When “index paper” is selected as the “paper type”, and in this state, “A3” that is not supported for the index paper is designated in the printer driver 301 from the application software, the UI control module 303 executes the conflict processing. As the result of conflict processing, since “A3” cannot be selected as the “page size”, print data is generated by setting “A4” stored as the “page size” to the paper size to be used in actual printing.

[Derivative Example]

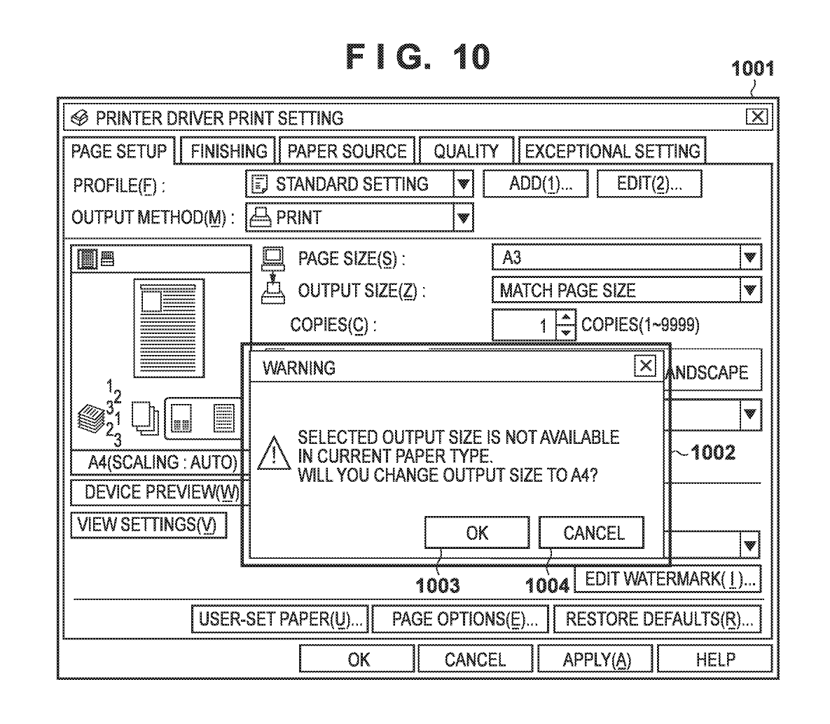

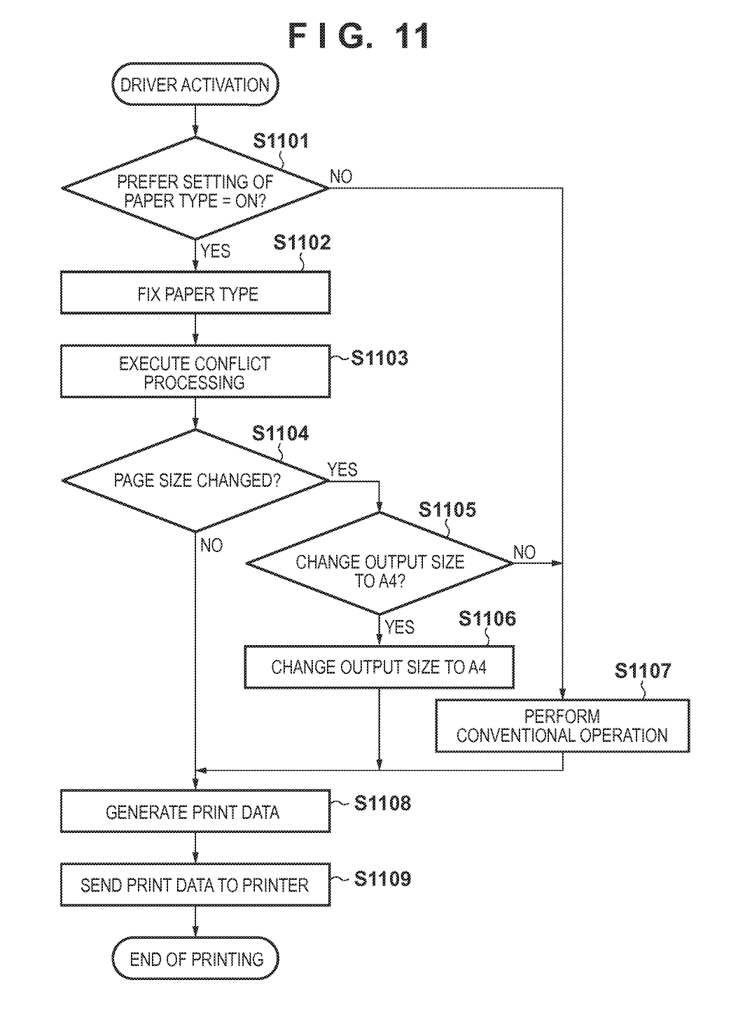

FIG. 10 shows a display example of a message provided by the printer driver according to a derivative form of the embodiment. FIG. 11 is a flowchart illustrating the derivative example.

When the printer driver 301 is activated at the time of printing execution by the application, the UI control module 303 determines in step S1101 whether the check box 702 “prefer setting of paper type” is selected. If the check box 702 is selected (YES in step S1101), the UI control module 303 fixes the “paper type” currently selected in the printer driver 301 to prefer it over selection of the paper size in step S1102. In this case, the UI control module 303, for example, sets an internal flag (not shown).

In step S1103, when the user who is operating the client computer 101 has set or changed a setting item in the display screen 601 of the printer driver 301, the UI control module 303 executes conflict processing. For example, examine a state in which “index paper” is selected as the “paper type” 505 in the “paper source” screen 504 shown in FIG. 5B, and “A4” is selected as the “page size” 502 in the “page setup” screen 501 shown in FIG. 5A. Assume that in this state, the user changes the “page size” 502 to “A3” that is not supported for “index paper”. At this point of time, the UI control module 303 executes conflict processing by reading the contents described in the printer specification description file 304. The UI control module 303 detects that “index paper” that is the already selected “paper type” and “A3” that is the “page size” selected by the immediately preceding operation have the conflict relationship.

In the related art, the message 602 shown in FIG. 6 is displayed to prompt the user to change the “paper type”. In this embodiment, however, if the user selects the check box 702 “prefer setting of paper type”, a message 1002 is displayed to ask for a permission to change the “output size” usable for printing.

In step S1104, the UI control module 303 confirms whether the user has changed the “page size” in the conflict processing of step S1103. If the “page size” is changed (YES in step S1104), in step S1105, the UI control module 303 displays the message 1002 to ask the user about switching the “output size”. As the value to be set by switching, a paper size (for example, “A4”) in the initial setting of the printer driver 301, which is stored in the printer specification description file 304 out of in the paper sizes supported for the “index paper”, is used. When the user selects an “OK” button 1003 in the message 1002 displayed in step S1105 (YES in step S1105), the UI control module 303 switches the paper size as the “output size” in accordance with the display contents of the message in step S1106. In the above example, the “output size” is changed from “match page size” to “A4”.

If the check box 702 is not selected (NO in step S1101), the UI control module 303 performs the conventional conflict processing in step S1107. When the user selects a “cancel” button 1004 in the message 1002 displayed in step S1105 (NO in step S1105), the UI control module 303 performs the conventional conflict processing in step S1107. In step S1108, the UI control module 303 generates print data. In step S1109, the UI control module 303 sends the generated print data to the network printers 102 and 103 via the network I/F controller 211, the computer network 104, and the like.

[Designation from Application]

Printing can also be executed from a document generation application, spreadsheet software, graphics processing software, or the like installed in the client computer 101 without displaying the user interface of the printer driver 301. These pieces of application software have the information of paper sizes. In, for example, the Windows® system, the information is designated in the printer driver 301 via the above-described DEVMODE.

This will be described in detail using the above example. When “index paper” is selected as the “paper type”, and in this state, “A3” that is not supported for the index paper is designated in the printer driver 301 from the application software, the UI control module 303 executes the conflict processing. As the result of conflict processing, since “A3” cannot be selected as the “page size”, the message 1002 is displayed to ask for a permission to change the “output size” usable for printing. The subsequent operation is the same as that from step S1105 in FIG. 11.

Note that when printing is executed without displaying the user interface of the printer driver 301, the message 1002 to ask for a permission to change the “output size” usable for printing need not always be displayed.

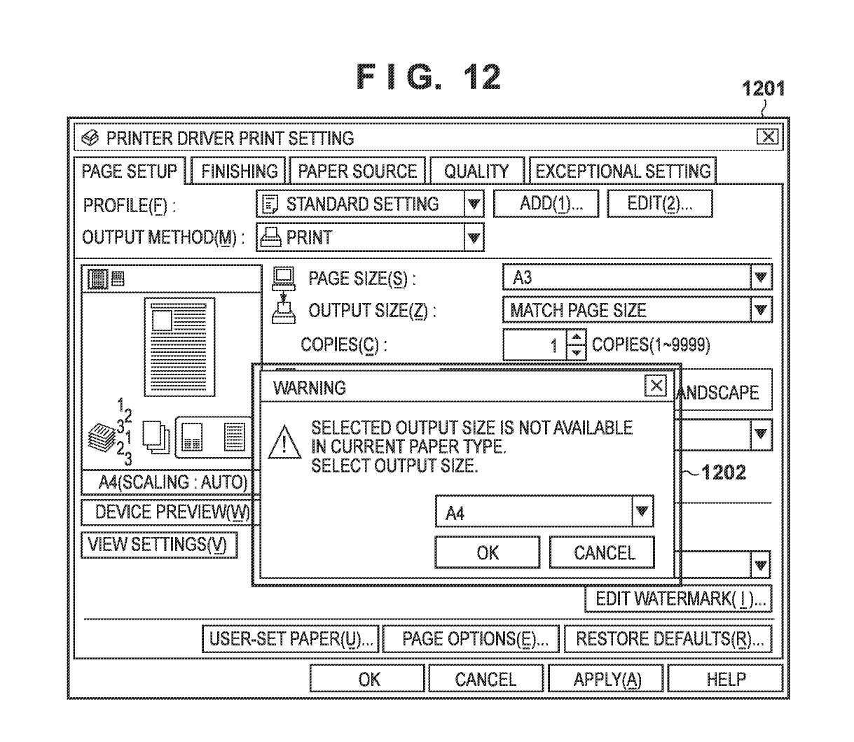

In place of the message 1002 to ask for a permission to change the “output size” usable for printing, as shown in FIG. 10, a message 1202 shown in FIG. 12 may be displayed to cause the user to select the output size from a plurality of paper sizes. In the above-described example, as the “output size” selectable in this case, only “A4” or “letter” supported for “index paper” may be changeable. When a plurality of selectable paper sizes are presented, a paper size of higher use frequency may be preferentially arranged at a higher rank of choices based on the information of, for example, a usage history of recently used paper. In FIG. 12, a paper size independently set by the user may be presented as a selectable candidate.

Only when the paper size has been changed, a message may be displayed to notify. If the user has input a print instruction without intervening the setting screen provided by the device driver, conflict processing and setting change may be done without displaying various messages.

In this embodiment, the initial set value is applied in step S1104. However, the present invention is not limited to this. The paper size may be decided from the paper size candidates corresponding to the paper type using the use frequency or the information of, for example, a usage history of recently used paper.

After execution of print processing, the actually used paper size and paper type may be presented.

This makes it possible to designate paper for printing and prevent print output using unintended paper by a simple operation.

### Second Embodiment

The second embodiment will be described with reference to FIGS. 1 to 4, 7, and 13A to 13C. Note that FIGS. 1 to 4 and 7 are the same as in the first embodiment, and a description thereof will not be repeated.

Some printer drivers provide a preview screen or a screen that enables to integrate or change at the time of printing for a plurality of original data. The embodiment will be explained in which when changing the output size in accordance with the conflict relationship, a setting screen corresponding to the function is displayed to enable to change the setting.

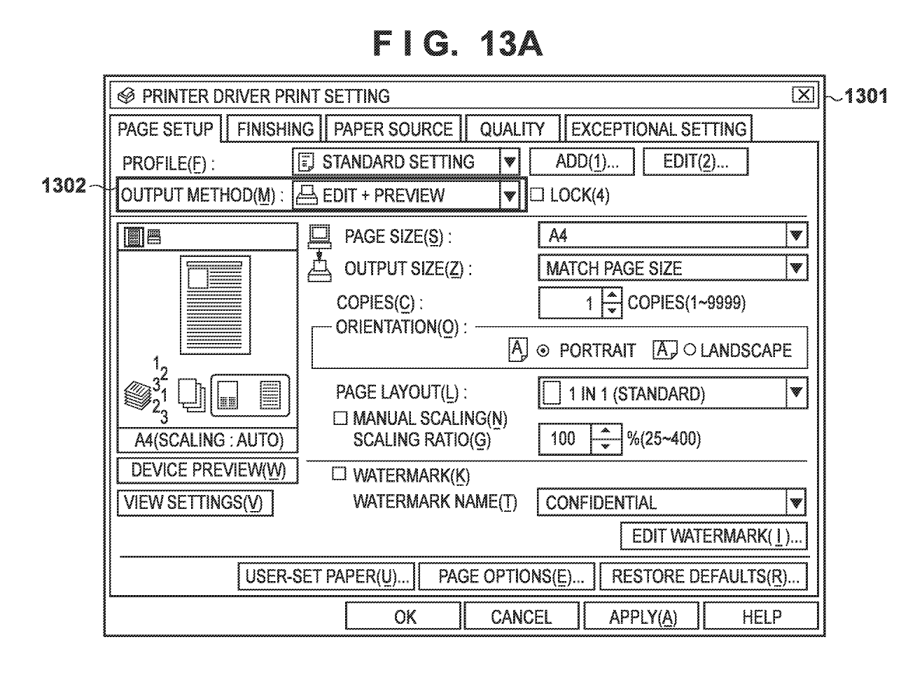

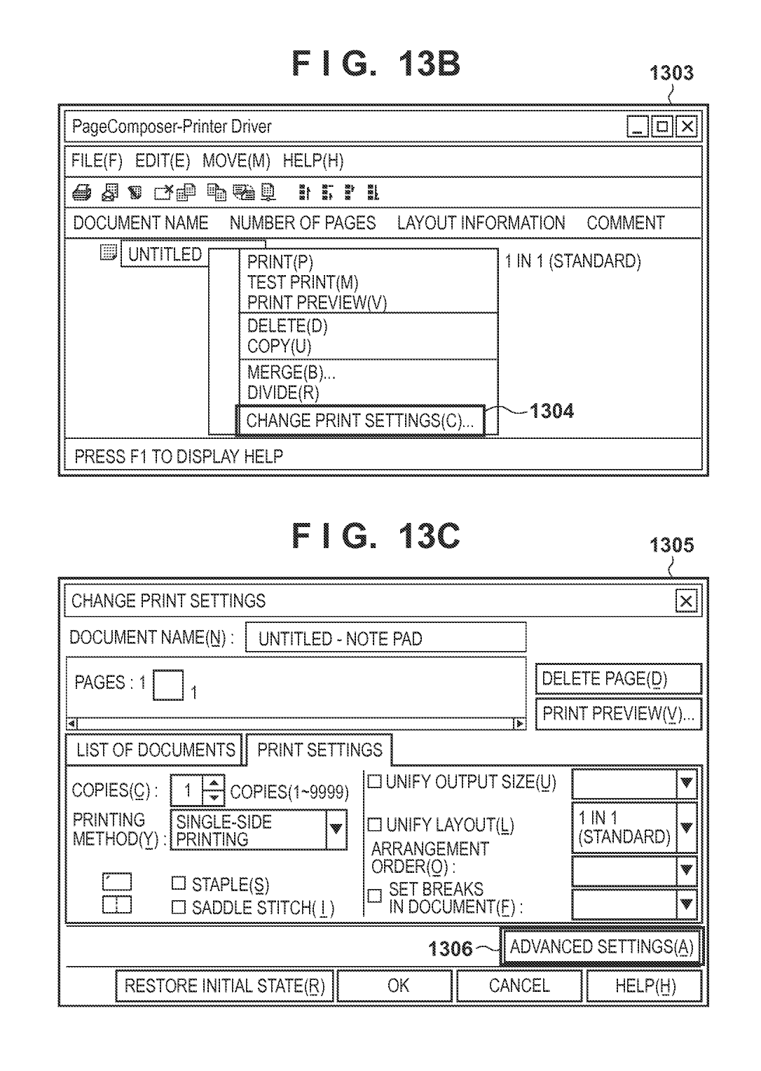

FIGS. 13A to 13C show display examples of screens provided by a printer driver according to the second embodiment. In this embodiment, a printer driver 301 has a setting item to switch to a screen for displaying a preview that is the output image of original data upon executing printing, as indicated by a setting item 1302 in a screen 1301 shown in FIG. 13A.

In a preview screen 1303 shown in FIG. 13B, the original data designated to be printed is displayed as an icon. Selecting the icon by, for example, clicking the right button of a mouse 213 allows the document to be edited, printed, or deleted or its settings to be changed. When “change print setting” 1304 is selected in the preview screen 1303, a screen 1305 for displaying various set contents related to printing is displayed, as shown in FIG. 13C. The setting change can also be done in the screen 1305. To do more detailed settings, the user can select an “advanced settings” button 1306 to display the screen of the printer driver 301. Normally, only when “edit+preview” is selected as the set value of the “output method”, as indicated by the setting item 1302, the preview screen 1303 is displayed upon printing.

In this embodiment, when a check box 702 shown in FIG. 7 is selected, and, for example, “index paper” is selected as the “paper type”, and in this state, “A3” that is not supported for the index paper is selected as the “page size”, conflict processing is performed.

As the result of conflict processing, since “A3” cannot be selected as the “page size”, a UI control module 303 switches the “output size” to “A4” stored as the “page size”. At this point of time, a flag representing the change of the “output size” or the like is stored in the storage unit (for example, RAM 204).

If the UI control module 303 detects the change of the stored “output size” upon executing actual printing, the “edit+preview” function acts to display the preview screen 1303 that allows preview and setting change. This implements a setting change reception unit.

In addition to the effects of the first embodiment, the user of the printer driver 301 can confirm the change of the output size from the displayed preview screen 1303 and further change the output size.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-095282, filed Apr. 21, 2011, which is hereby incorporated by reference herein in its entirety.

What is claimed is:

1. An information processing apparatus comprising:
a holding unit configured to hold an output size and a paper type to be used by a printing apparatus when printing original data;
a conflict processing unit configured to determine, based on a predetermined conflict condition, a conflict relationship representing an unselectable combination of a size and a type of paper; and
a priority setting reception unit configured to receive a priority setting for one of the paper type held by said holding unit and a page size designated by the original data under the predetermined conflict condition,
wherein when the priority setting is done for the paper type, and the paper type and the page size satisfy the conflict relationship, said conflict processing unit changes the output size so as not to satisfy the conflict relationship to the paper type while keeping setting of the page size unchanged.

2. The apparatus according to claim 1, wherein when the paper type is preferred, and the paper type and the page size satisfy the conflict relationship, said conflict processing unit displays a screen to change the output size to a size that does not satisfy the conflict relationship to the paper type.

3. The apparatus according to claim 2, wherein when a user has changed the page size, said conflict processing unit does not display the screen to change the output size.

4. The apparatus according to claim 1, wherein said conflict processing unit changes the output size in accordance with one of a use frequency, a usage history, and an initial setting.

5. The apparatus according to claim 1, wherein when the paper type is preferred, and the paper type and the page size have the conflict relationship, said conflict processing unit displays a screen that allows to change the output size by selecting the output size from a plurality of paper sizes that do not have the conflict relationship to the paper type.

6. The apparatus according to claim 5, wherein in the screen that allows to change the output size by selecting the output size from the plurality of paper sizes, the plurality of paper sizes are sequentially presented using one of a use frequency, a usage history, and an initial setting as a reference.

7. An information processing apparatus comprising:
a holding unit configured to hold an output size and a paper type to be used by a printing apparatus when printing original data;
a conflict processing unit configured to determine, based on a predetermined conflict condition, a conflict relationship representing an unselectable combination of a size and a type of paper;
a setting change reception unit configured to display an output image of the original data and to receive a setting change for the original data; and
a priority setting reception unit configured to receive a priority setting for one of the paper type held by said holding unit and a page size designated by the original data under the predetermined conflict condition,
wherein when the priority setting is done for the paper type, and the paper type and the page size satisfy the conflict relationship,
said conflict processing unit changes the output size so as not to satisfy the conflict relationship to the paper type while keeping setting of the page size unchanged, and
said setting change reception unit displays the output image and receives a change of the output size from a user.

8. A print setting method comprising:
a holding step of holding, in a storage unit in advance, an output size and a paper type to be used by a printing apparatus when printing original data;
a conflict processing step of determining, based on a predetermined conflict condition, a conflict relationship representing an unselectable combination of a size and a type of paper; and
a priority setting reception step of receiving a priority setting for one of the paper type held in the storage unit and a page size designated by the original data under the predetermined conflict condition,
wherein when the priority setting is done for the paper type, and the paper type and the page size satisfy the conflict relationship, in the conflict processing step, the output size is changed so as not to satisfy the conflict relationship to the paper type while keeping setting of the page size unchanged.

9. A print setting method comprising:
a holding step of holding, in a storage unit in advance, an output size and a paper type to be used by a printing apparatus when printing original data;
a conflict processing step of determining, based on a predetermined conflict condition, a conflict relationship representing an unselectable combination of a size and a type of paper;
a setting change reception step of displaying an output image of the original data and receiving a setting change for the original data; and
a priority setting reception step of receiving a priority setting for one of the paper type held in the storage unit and a page size designated by the original data under the predetermined conflict condition,
wherein when the priority setting is done for the paper type, and the paper type and the page size satisfy the conflict relationship,
in the conflict processing step, the output size is changed so as not to satisfy the conflict relationship to the paper type while keeping setting of the page size unchanged, and
in the setting change reception step, the output image is displayed, and a change of the output size from a user is received.

10. A computer-readable medium storing a program that causes a computer to function as:
holding unit configured to hold an output size and a paper type to be used by a printing apparatus when printing original data;
conflict processing unit configured to determine, based on a predetermined conflict condition, a conflict relationship representing an unselectable combination of a size and a type of paper; and
priority setting reception unit configured to receive a priority setting for one of the paper type held by said holding unit and a page size designated by the original data under the predetermined conflict condition,
wherein when the priority setting is done for the paper type, and the paper type and the page size satisfy the conflict relationship, said conflict processing unit changes the output size so as not to satisfy the conflict relationship to the paper type while keeping setting of the page size unchanged.

11. A computer-readable medium storing a program that causes a computer to function as:
a holding unit configured to hold an output size and a paper type to be used by a printing apparatus when printing original data;
a conflict processing unit configured to determine, based on a predetermined conflict condition, a conflict relationship representing an unselectable combination of a size and a type of paper;
a setting change reception unit configured to display an output image of the original data and to receive a setting change for the original data; and
a priority setting reception unit configured to receive a priority setting for one of the paper type held by said holding unit and a page size designated by the original data under the predetermined conflict condition,
wherein when the priority setting is done for the paper type, and the paper type and the page size satisfy the conflict relationship,
said conflict processing unit changes the output size so as not to satisfy the conflict relationship to the paper type while keeping setting of the page size unchanged, and
said setting change reception unit displays the output image and receives a change of the output size from a user.
